(19) United States
(12) Patent Application Publication
(10) Pub. No.: US 2024/0095288 A1
(43) Pub. Date: Mar. 21, 2024

(54) SYSTEM AND METHOD OF PERFORMANT CONTENT SOURCE CRAWLING

(71) Applicant: SHINYDOCS CORPORATION, Kitchener (CA)

(72) Inventors: Peter VANLEEUWEN, Guelph (CA); Jason William David CASSIDY, Kitchener (CA); Mark KRAATZ, London (CA); Abdulrahman ALAMOUDI, Ottawa (CA); Benjamin BARTH, Waterloo (CA); Robert HASKETT, Kitchener (CA); Mervin BOWMAN, Kitchener (CA); Gorgi TERZIEV, Strumica (MK)

(21) Appl. No.: 18/468,931

(22) Filed: Sep. 18, 2023

Related U.S. Application Data
(60) Provisional application No. 63/407,716, filed on Sep. 18, 2022.

(51) Int. Cl. G06F 16/951; G06F 16/16

(52) U.S. Cl. CPC G06F 16/951; G06F 16/16

(57) ABSTRACT

A system and method of improved performant content source crawling. A content source crawling technology that is performant and focused on an initial rapid crawling of a content source to find specific file signatures so that it can determine an inventory of files that have been modified since the last full index event, thereby minimizing the time and computing resources necessary to perform a full crawl on just the select files to update to the search index. A method of Signature Flagging is disclosed and is used to selectively crawl the metadata about contained files and folders found within a content source in order to create that information in an Index within the Shinydocs Search Library.

### CROSS REFERENCE TO RELATED APPLICATION

This application claims priority and the benefit of U.S. Provisional Patent Application Ser. No. 63/407,716, entitled “SYSTEM AND METHOD OF PERFORMANT FILE SYSTEM CRAWLING”, filed on Sep. 18, 2022, the disclosure of which is incorporated herein by reference in its entirety.

### FIELD

This disclosure relates to computer systems and, more specifically, to remote file storage and access.

### BACKGROUND

Virtually every organization produces electronic files during their operations. As a result, there is a need to electronically store these files and data and make them commonly available for use by individual members of the organization. Some organizations employ the use of complex Content Management (CM) systems or Enterprise Content Management (ECM) systems to store files and other data for access by users of an organization's computers. Other organizations use other types of file share solutions to make information available to their users. Regardless of type, all of these file sharing systems, or Content Sources, represent a challenge to maintain and make use of their content effectively.

Since the start of the digital revolution, organizations have been creating digital content at an accelerating pace without considering how to find, manage and action all these unstructured documents. At a mid-sized company, this can amount to hundreds of terabytes (TB) of data (which corresponds to hundreds of millions of documents). At a large-sized company this can amount to petabytes (PB) of data (each petabyte corresponds to about a billion documents).

Organizations that do not actively manage their stored data within their content source are exposing a number of unnecessary costs and risks including the following:
Retention of very large or even huge files (10 GB+) that are not needed, take up valuable storage space that could be used for something else. Lack of knowing about and neglecting to delete such files can lead to unnecessarily paying for excess storage. Additionally, performing searches of the bloated content source will add “noise” to search results.
Very old files (last modified date more than 7 years typically) that are not being accessed by anyone also unnecessarily take up space. Further, certain compliance standards require that defunct records and files be deleted, but in an unmanaged content source, may be left in storage, exposing the organization to a non-compliance risk.
The presence of files that could be considered unnecessary or trivial, also take up space and are certainly cluttering up searches for documents, since they are included in search results.
There is also a risk of the content source containing confidential files that are improperly filed or permissioned, or simply stored improperly for security purposes.
There may be a need to have certain files locked down for legal purposes, such as a legal hold. If they are improperly handled in this situation, they could be compromised or possibly deleted, either intentionally or inadvertently. Mishandling of these types of files are a significant risk, financially and/or legally, to the organization.

Due to the massive amount of data that is typically contained in a content source, the ability to summarize and understand what files are there (based on the content source metadata i.e., file name, path, size, extension, creation date, last modified date) is very powerful. This is usually performed by performing a system crawl to extract and organize that information into an index, or searchable table. There are tools that exist to help do this, but they are generally very slow (a crawl speed of a couple of dozen files per second, for example), making it difficult to gain this understanding in a reasonable amount of time. In some cases, the organic growth of the data can outstrip the time it takes to crawl it. More servers can be deployed for this task, but this is generally a linear scaling situation (i.e., to make it ten times faster, computing resources must be increased by a factor of ten), hence this is not a reasonable solution.

There is a desire to provide a tool that provides better and improved content source and file share crawling for the purposes of creating a searchable content index. Sending data to be indexed is a costly operation in terms of time and computing resources required as a full indexing operation seeks to read all of the content of every file or document. This invention describes a methodology to minimize the amount of data to be crawled, using file properties, attributes or metadata to assess the need for a given file to be subject to crawl. By reducing the number of files that need to be crawled, preventing the resource-costly crawling of files that have not changed since the last crawl, a crawl/index update process can be performed in a fraction of the time.

### SUMMARY

A system and method of improved performant content source crawling. A content source crawling technology that is performant and focused on an initial rapid crawling of a content source to find specific file signatures so that it can determine an inventory of files that have been modified since the last full index event, thereby minimizing the time and computing resources necessary to perform a full crawl on just the select files to update to the search index. A method of Signature Flagging is disclosed and is used to selectively crawl the metadata about contained files and folders found on a source Content source in order to create that information in an Index within the Shinydocs Search Library.

### BRIEF DESCRIPTION OF THE DRAWINGS

The drawings illustrate, by way of example only, embodiments of the present disclosure.

FIG. 1 is a block diagram of a networked computer system.

FIG. 2 is a block diagram of a user computer device.

FIG. 3 is a schematic diagram illustrating architecture for file sharing.

FIG. 4 is a flow diagram illustrating an exemplary performant content source crawling process.

FIG. 5 is a flow diagram illustrating the iterative content source crawling process informed by document signature flags.

### DETAILED DESCRIPTION

This disclosure concerns exposing a content source, (such as a remote content management or file storage system) to a server running the Shinydocs Cognitive Suite. Shinydocs Cognitive Suite is a content management interface system. Information will be transferred from the remote content management system to the Cognitive Suite, which will then be embellished using various automated methods to assign attributes to each of these documents (in the Cognitive Suite).

This disclosure describes a methodology to minimize the amount of data to be crawled, using file properties to assess the need for a given file to be subject to crawl. By reducing the number of files that need to be crawled, preventing the resource-costly crawling of files that have not changed since the last crawl, a crawl/index update process can be performed in a fraction of the time.

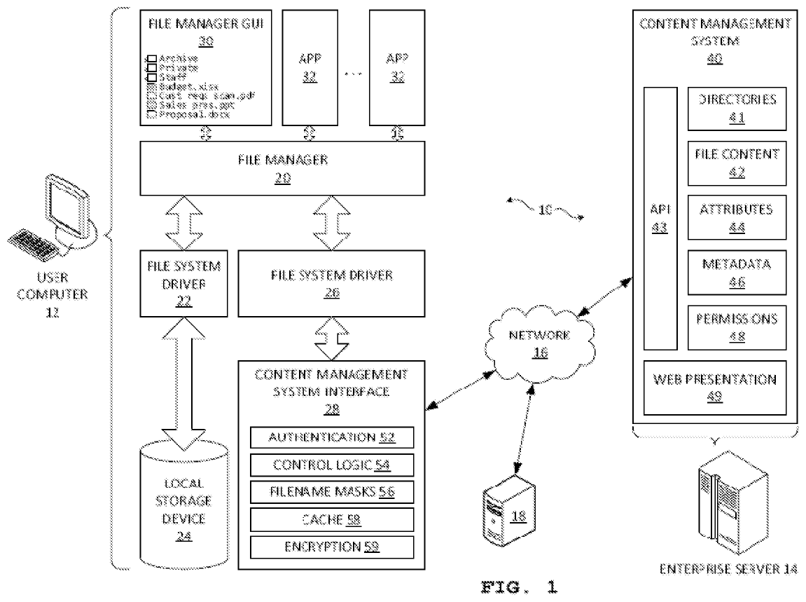

FIG. 1 shows a networked computer system 10 according to the present invention. The system 10 includes at least one user computer device 12 and at least one server 14 connected by a network 16.

The user computer device 12 can be any computing device such as a desktop or notebook computer, a smartphone, tablet computer, and the like. The user computer device 12 may be referred to as a computer.

The server 14 is a device such as a mainframe computer, blade server, rack server, cloud server, or the like. The server 14 may be operated by a company, government, or other organization and may be referred to as an enterprise server or an enterprise content management (ECM) system.

The network 16 can include any combination of wired and/or wireless networks, such as a private network, a public network, the Internet, an intranet, a mobile operator's network, a local-area network, a virtual-private network (VPN), and similar. The network 16 operates to communicatively couple the computer device 12 and the server 14.

In a contemplated implementation, a multitude of computer devices 12 connect to several servers 14 via an organization's internal network 16. In such a scenario, the servers 14 store documents and other content in a manner that allows collaboration between users of the computer devices 12, while controlling access to and retention of the content. Such an implementation allows large, and often geographically diverse, organizations function. Document versioning or/and retention may be required by some organizations to meet legal or other requirements.

The system 10 may further include one or more support servers 18 connected to the network 16 to provide support services to the user computer device 12. Examples of support services include storage of configuration files, authentication, and similar. The support server 18 can be within a domain controlled by the organization that controls the servers 14 or it can be controlled by a different entity.

The computer device 12 executes a file manager 20, a local-storage content source driver 22, a local storage device 24, a remote-storage content source driver 26, and a content management system interface 28.

The file manager 20 is configured for receiving user file commands from a user interface (e.g., mouse, keyboard, touch screen, etc.) and outputting user file information via the user interface (e.g., display). The file manager 20 may include a graphical user interface (GUI) 30 to allow a user of the computer 12 to navigate and manipulate hierarchies of folders and files, such as those residing on the local storage device 24. Examples of such include Windows' Explorer and macOs Finder. The file manager 20 may further include an application programming interface (API) exposed to one or more applications 32 executed on the computer 12 to allow such applications 32 to issue commands to read and write files and folders. Generally, user file commands include any user action (e.g., user saves a document) or automatic action (e.g., application's auto-save feature) performed via the file manager GUI 30 or application 32 that results in access to a file. The file manager GUI 30 and API may be provided by separate programs or processes. For the purposes of this disclosure, the file manager 20 can be considered to be one or more processes and/or programs that provide one or both of the file manager GUI 30 and the API.

The local-storage content source driver 22 is resident on the computer 12 and provides for access to the local storage device. The content source driver 22 responds to user file commands, such as create, open, read, write, and close, to perform such actions on files and folders stored on the local storage device 24. The content source driver 22 may further provide information about files and folders stored on the local storage device 24 in response to requests for such information.

The local storage device 24 can include one or more devices such as magnetic hard disk drive, optical drives, solid-state memory (e.g., flash memory), and similar.

The remote-storage content source driver 26 is coupled to the file manager 20 and is further coupled to the content management system interface 28. The content source driver 26 maps the content management system interface 28 as a local drive for access by the file manager 20. For example, the content source driver 26 may assign a drive letter (e.g., “H:”) or mount point (e.g., “/Enterprise”) to the content management system interface 28. The content source driver 26 is configured to receive user file commands from the file manager 20 and output user file information to the file manager 20. Examples of user file commands include create, open, read, write, and close, and examples of file information include file content, attributes, metadata, and permissions.

The remote-storage content source driver 26 can be based on a user-mode content source driver. The remote-storage content source driver 26 can be configured to delegate callback commands to the content management system interface 28. The callback commands can include content source commands such as Open, Close, Cleanup, CreateDirectory, OpenDirectory, Read, Write, Flush, GetFilelnformation, GetAttributes, FindFiles, SetEndOfFile, SetAttributes, GetFileTime, SetFileTime, LockFile, UnLockFile, GetDiskFreeSpace, GetFileSecurity, and SetFileSecurity.

The content management system interface 28 is the interface between the computer 12 and the enterprise server 14. The content management system interface 28 connects, via the network 16, to a content management system 40 hosted on the enterprise server 14. As will be discussed later in this document, the content management system interface 28 can be configured to translate user commands received from the driver 26 into content management commands for the remote content management system 40.

The content management system interface 28 is a user-mode application that is configured to receive user file commands from the file manager 20, via the driver 26, and translate the user file commands into content management commands for sending to the remote content management system 40. The content management system interface 28 is further configured to receive remote file information from the remote content management system 40 and to translate the remote file information into user file information for providing to the file manager 20 via the driver 26.

The remote content management system 40 can be configured to expose an API 43 to the content management system interface 28 in order to exchange commands, content, and other information with the content management system interface 28. The remote content management system 40 stores directory structures 41 containing files in the form of file content 42, attributes 44, metadata 46, and permissions 48. File content 42 may include information according to one or more file formats (e.g., “.docx”, “.txt”, “.dxf”, etc.), executable instructions (e.g., an “.exe” file), or similar. File attributes 44 can include settings such as hidden, read-only, and similar. Metadata 46 can include information such as author, date created, date modified, tags, file size, and similar. Permissions 48 can associate user or group identities to specific commands permitted (or restricted) for specific files, such as read, write, delete, and similar.

The remote content management system 40 can further include a web presentation module 49 configured to output one or more web pages for accessing and modifying directory structures 41, file content 42, attributes 44, metadata 46, and permissions 48. Such web pages may be accessible using a computer's web browser via the network 16.

The content management system interface 28 provides functionality that can be implemented as one or more programs or other executable elements. The functionality will be described in terms of distinct elements, but this is not to be taken as limiting. In specific implementations, not all of the functionality needs to be implemented.

The content management system interface 28 includes an authentication component 52 that is configured to prompt a user to provide credentials for access to the content management system interface 28 and for access to the remote content management system 40. Authentication may be implemented as a username and password combination, a certificate, or similar, and may include querying the enterprise server 14 or the support server 18. Once the user of the computer device 12 is authenticated, he or she may access the other functionality of the content management system interface 28.

The content management system interface 28 includes control logic 54 configured to transfer file content between the computer 12 and the server 14, apply filename masks, evaluate file permissions and restrict access to files, modify file attributes and metadata, and control the general operation of the content management system interface 28. The control logic 54 further affects mapping of remote paths located at the remote content management system 40 to local paths presentable at the file manager 20. Path mapping permits the user to select a file via the final manager 20 and have file information and/or content delivered from the remote content management system 40. In one example, the remote files and directories are based on a root path of “hostname/directory/subdirectory” that is mapped to a local drive letter or mount point and directory (e.g., “H:/hostname/directory/subdirectory”).

The content management system interface 28 includes filename masks 56 that discriminate between files that are to remain local to the computer 12 and files that are to be transferred to the remote content management system 40. Temporary files may remain local, while master files that are based on such temporary files may be sent to the remote content management system 40. This advantageously prevents the transmission of temporary files to the remote content management system 40, thereby saving network bandwidth and avoiding data integrity issues (e.g., uncertainty and clutter) at the remote content management system 40.

The content management system interface 28 includes a cache 58 of temporary files, which may include working versions of files undergoing editing at the user computer device 12 or temporary files generated during a save or other operating of an application 32.

The content management system interface 28 includes an encryption engine 59 configured to encrypt at least the cache 58. The encryption engine 59 can be controlled by the authentication component 52, such that a log-out or time out triggers encryption of the cache 58 and successful authentication triggers decryption of the cache 58. Other informational components of the content management system interface 28 may be encrypted as well, such as the filename masks 56. The encryption engine 59 may conform to an Advanced Encryption Standard (AES) or similar.

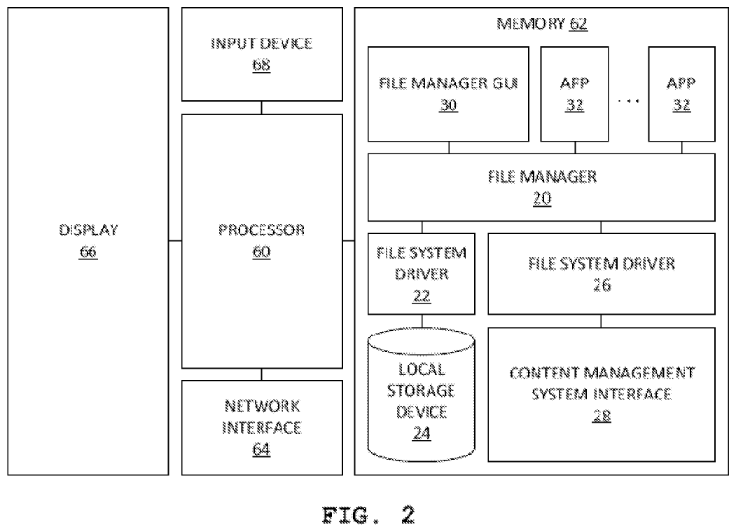

FIG. 2 shows an example of a user computer device 12. The computer device 12 includes a processor 60, memory 62, a network interface 64, a display 66, and an input device 68. The processor 60, memory 62, network interface 64, display 66, and input device 68 are electrically interconnected and can be physically contained within a housing or frame.

The processor 60 is configured to execute instructions, which may originate from the memory 62 or the network interface 64. The processor 60 may be known as CPU. The processor 60 can include one or more processors or processing cores.

The memory 62 includes a non-transitory computer-readable medium that is configured to store programs and data. The memory 62 can include one or more short-term or long-term storage devices, such as a solid-state memory chip (e.g., DRAM, ROM, non-volatile flash memory), a hard drive, an optical storage disc, and similar. The memory 62 can include fixed components that are not physically removable from the client computer (e.g., fixed hard drives) as well as removable components (e.g., removable memory cards). The memory 62 allows for random access, in that programs and data may be both read and written.

The network interface 64 is configured to allow the user computer device 12 to communicate with the network 16 (FIG. 1). The network interface 64 can include one or more of a wired and wireless network adaptor as well as a software or firmware driver for controlling such adaptor.

The display 66 and input device 68 form a user interface that may collectively include a monitor, a screen, a keyboard, keypad, mouse, touch-sensitive element of a touch-screen display, or similar device.

The memory 62 stores the file manager 20, the content source driver 26, and the content management system interface 28, as well as other components discussed with respect to FIG. 1. Various components or portions thereof may be stored remotely, such as at a server. However, for purposes of this description, the various components are locally stored at the computer device 12. Specifically, it may be advantageous to store and execute the file manager 20, the content source driver 26, and the content management system interface 28 at the user computer device 12, in that a user may work offline when not connected to the network 16. In addition, reduced latency may be achieved. Moreover, the user may benefit from the familiar user experience of the local file manager 20, as opposed to a remote interface or an interface that attempts to mimic a file manager.

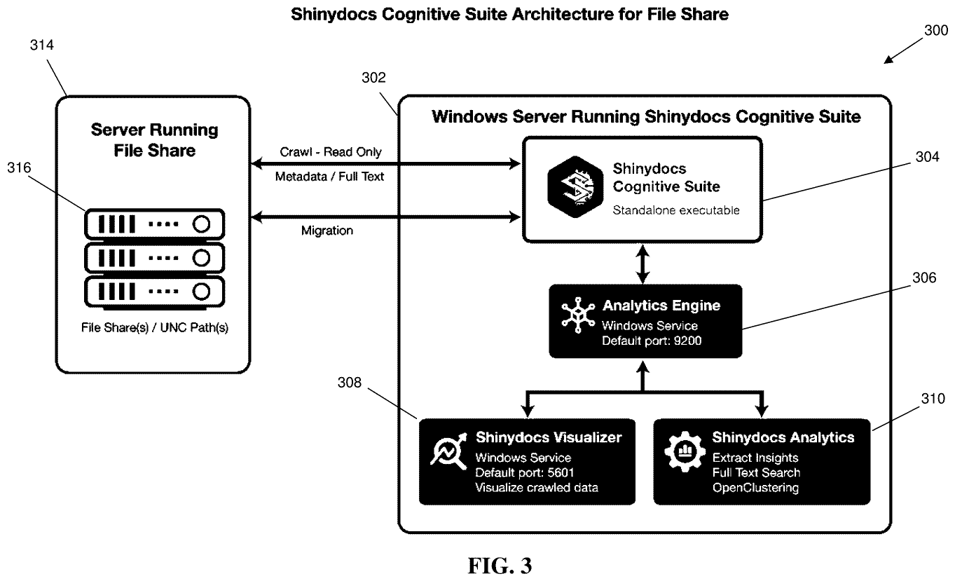

FIG. 3 is a schematic diagram illustrating architecture for file sharing including Analytics Engine within Shinydocs Cognitive Suite. According to FIG. 3, diagram 300 illustrates a Windows Server 302 running Shinydocs Cognitive Suite 304, Analytics Engine 306, Shinydocs Visualizer 308 and Shinydocs Analytics 310.

According to FIG. 3, a separate server 314 is shown running File Shares 316. The File Shares 316, or Enterprise Content Management systems, content sources or file shares contain files of various sizes, many of which contain text. The Shinydocs Cognitive Suite 304 can be a standalone executable that extracts metadata from these file shares which are stored in the Analytics Engine 306. The Shinydocs Cognitive Suite 304 likewise extracts text from files in these file shares, which are also stored in the Analytics Engine 110.

According to FIG. 3, Analytics Engine 306 can programmatically break apart large chunks of text when doing text extraction and will likewise logically recombine those large chunks of text for operations such as search for strings of text that are contained in the extracted text.

The Analytics Engine 306 described in FIG. 3 is part of the Shinydocs Cognitive Suite 104 and interfaces with the Shinydocs Visualizer 308 and Shinydocs Analytics 310 components (or modules). The Shinydocs Visualizer module 308 enables visualization of crawled data and enables a windows service to connect to a default port (e.g., port 5601). The Shinydocs Analytics module 310 is configured to extract insights, perform full text searches and perform open clustering.

According to FIG. 3, the Analytics Engine 306 also leverages open-source search applications (such as Elasticsearch or Open Search) as the underlying technology. In this description, Elasticsearch is referenced as the search engine, but is interchangeable with other similar open-source search engines. Furthermore, Analytics Engine 306 is also configured as a Windows Service enabling connection to a default port (e.g., port 9200).

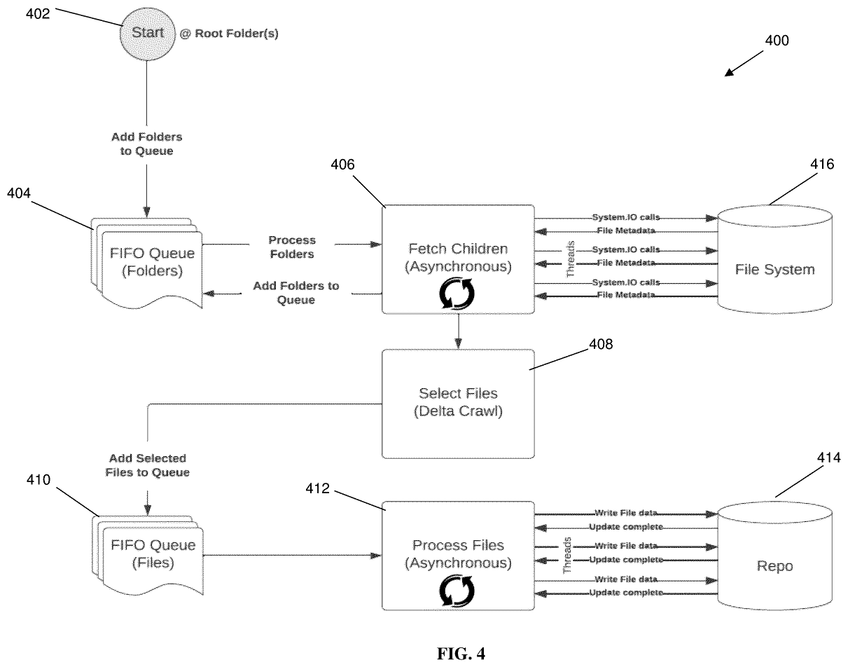

FIG. 4 is a workflow diagram illustrating an exemplary performant content source crawling process. According to FIG. 4, the workflow 400 starts at the root folder 402 where folders are added to a Folders FIFO Queue 404. The system processes the folders and fetches child folders asynchronously 406 with the content source database 416 via system IO calls and file metadata.

According to FIG. 4, the system then selects the files via a delta crawl 408 and adds the selected files to the Files FIFO Queue 410. The next step is to process the files asynchronously 412 with a Repo database 412 via multiple threads that manage write file data and update complete acknowledgement messages.

This disclosure relates to the optimization of a content source crawl achieved via processes which minimize the amount of content that is to be processed by any one iteration of the crawl and by utilizing any available computing system resources that can enable crawl speed enhancements. This is accomplished via a determination, prior to the execution of the crawl, of which files will need to be subject to a crawl via detection of a defined number of signatures which identify files that have changed since the last recorded crawl event. A signature is a file attribute that can be defined by the user or administrator and is generally found in the file metadata or attributes. Once files have been identified as containing the desired signatures, only those files are subject to the crawl process for the operation known as Update and Insert (upsert) into the index.

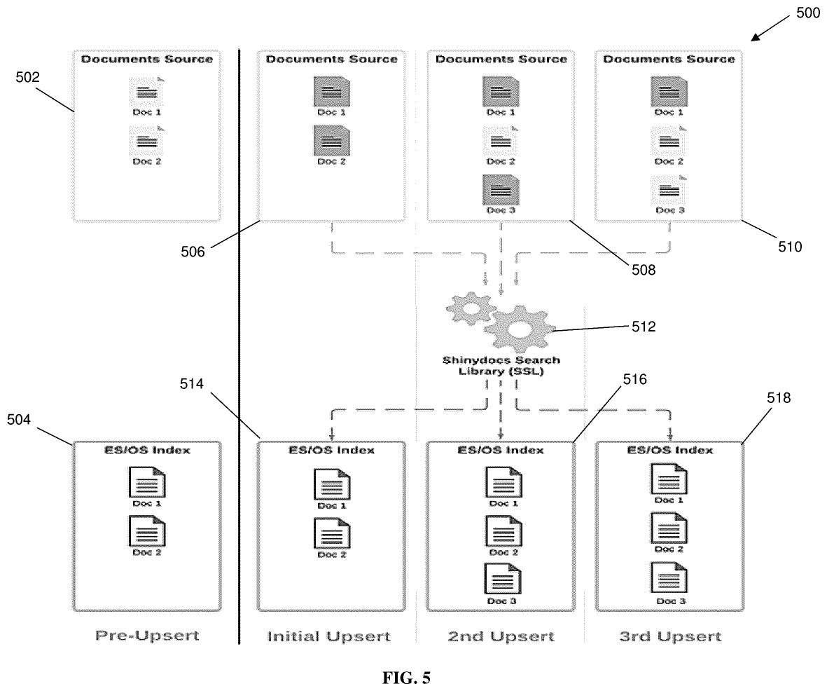

FIG. 5 is a workflow diagram illustrating an iterative series of crawls applied against an existing indexed Document (File) Source to perform an upsert to the Shinydocs Search Library (SSL) containing the Index for the content of that Document Source.

In FIG. 5, the Pre-Upsert process 500 consists of a Document Source 502, containing multiple documents, being crawled completely to produce a baseline Search Index 504, (indicated as ES/OS, representing Elasticsearch and Open Search, representative of open-source search engines used by Shinydocs), which contains the desired signature attributes of every document from the source.

FIG. 5 also shows subsequent upsert iterations in which Source Documents (506, 508 and 510) are examined for evidence that they have been changed since the previous upsert process. Documents that have been proven to have been changed are then updated in the Index following the upsert iteration. Documents that have not been identified as having changed are excluded from this iteration of the upsert. and are therefore retained “as-is” in the index.

This part of the invention discloses a signature flagging feature integral to the update and insert (upsert) functionality within the Shinydocs Search Library (SSL) 512 that is intended to bring massive efficiency to the crawl and index process. It works by attaching and running a special script that gets executed prior to every single upsert crawl operation (i.e., Initial Upsert, 2^{nd} Upsert, 3^{rd} Upsert) to create subsequent ES/OS Indexes (514, 516 and 518). One may think of it as a conditional upsert or an upsert with extra logic. The upsert documents functionality within SSL distinguishing between documents with signatures and those without. Given that upserts should handle different types of documents, there is a need to enforce having the Signature property present in all of those documents for SSL to enable such a feature. Thus, a new interface called IShinydocsDocument is introduced, and it is required to upsert documents using the SSL 512.

### Signature Detection

New or modified documents: This part of the invention searches for and generates a signature flag for documents that have been added and/or modified since the last index of record was established.

The search for files with modified signatures takes place during a preliminary crawl of the content source in which the crawler only searches for new documents or modified document markers (signatures) in the object hash id. These markers can be defined by the user or administrator and can look for any marker or file attribute that the user deems to be important. From this, a modified crawl list is created which is to be used for the subsequent, full crawl actions. This initial pass can be conducted very quickly since the crawler is only looking at selected attributes and is not reading the content of the document. As a result, the subsequent crawl(s) are only applied to a greatly-reduced subset of all of the content source files, thereby substantially reducing the time and resource requirements for the crawl(s) needed to update or extend the index.

This part of the invention also enables the Administrator to specify an “after date last modified” value, if desired, which can be a specific date or can be a relative value (e.g., “now −1 day”). If specified, this leverages the content source itself to limit what files are crawled by comparing their last modified date recorded in the Index to that of the file in its native location, which greatly reduces the actual number of files that have to be crawled each time. Otherwise, the assessment crawl is expected to only identify files that have changed since the last crawl and will exclude any unchanged files from the full index operation, leaving them unchanged in the SSL. In the event a file is changed while either the signature search operation or crawl/index operations are underway, the system would recognize the change in the next iteration of these operations as the Index date information for that file would be unchanged and the source file date information would be discovered in the next assessment.

### File Validation (-Validate Option):

The File Validation component consists of the following:
This part of the disclosure is to note the generation of a toggle option to take advantage of the regular content source crawling, when the -validate option is specified. If specified, and if an existing Shinydocs Search Library has a record of any file and that file is no longer found (due to it being renamed, moved or deleted), it will be marked in the SSL as invalid. These files tagged as invalid will be automatically omitted from the crawl operation.
To find the files to be marked as invalid, a special query is used on the index to find unique parent folders with which to compare the folder children, and another query is used to find the file children of a folder. When comparing this with the previous crawler record, it can be found which folders/files no longer exist and can therefore be marked as “invalid” in the search repository.

### Content Source Crawling Performance:

The content source crawling performance is adaptable to take advantage of hardware capabilities on the host system. This includes, but is not limited to:

Multi-threading: by determining how many processors are present in the host system, the module can improve throughput speeds by initiating multiple processing threads to perform upsert processes in parallel. The ability to thread and specification of thread numbers is configurable and controllable as an administrator setting.

Multiple Path Support: This part of the invention enables an Administrator to specify multiple file paths for crawling with each run of the CrawlFileSystem tool. If specified, these will be done in parallel on different threads within the tool itself (so when the crawling of one path completed, another could be started without impacting other crawling that was happening on other threads). As a result, the process has become more stable and executes much more quickly when multiple paths were being simultaneously crawled. An implementation of a shared queue provides the application the ability to support multiple paths by pre-populating the queries.

According to the disclosure, a computer-implemented method of crawling data of a performant content system using an Analytics Engine and an enterprise content management system is disclosed. The computer-implemented method comprising the steps of providing a computer processor, configuring the processor to couple with a network interface. The method further comprises the steps of configuring the processor, by a set of executable instructions storable in a memory, configured to add a folder to a first in first out (FIFO) folder queue and process the folders and fetch child folders asynchronously.

The method further comprises the step of selecting one or more files via a delta crawl and add the selected file to the Files FIFO Queue and processing the files asynchronously with a Repo database. The method minimizes the amount of data to be crawled using file properties to assess the need for a given file to be subject to crawl. Furthermore, prior to the execution of the crawl, the files are subject to a crawl via detection of a number of signatures which identify files that have changed since the last recorded crawl event. The files are also identified as containing the desired signatures and only those files are subject to the crawl process and added to the index.

According to the disclosure, computer-implemented method starts at the root folder where folders are added to a Folders First in First Out (FIFO) Queue. The system of the computer-implemented processes the folders and fetches child or children folders asynchronously with the file system database via system input output (IO) calls and file metadata.

According to the disclosure, the computer-implemented method further comprises the step of updating complete acknowledgement messages. The method further comprises the step of processing the files asynchronously with a Repo database via multiple threads that manage write file data.

According to the disclosure, the computer-implemented method minimizes the amount of content that is to be processed by any one iteration of the crawl and by utilizing available computing system resources that can enable crawl speed enhancements. Furthermore, adding files to the index of the computer-implemented method further comprises including an Update and upsert (or insert) into the index.

According to the disclosure, the file of the computer-implemented method comprises file properties configured to prevent a file from being crawled and the file is a temporary file or is specifically flagged not to be crawled.

According to further embodiments of the disclosure, a performant file system configured for crawling data in an enterprise content management system is disclosed. The system comprises a computer processor, one or more file share of the content management system configured to store one or more original document, a content management system module configured to communicate with the file share of the content management system, an analytics module, a visualizer module configured to provide output and visualization of crawled data and an analytics engine, in communication with the content management system module and the visualizer and analytics modules. The analytics engine is configured to add a folder to a first in first out (FIFO) folder queue and process the folders and fetch child folders asynchronously.

According to the disclosure, the system is configured to select one or more files via a delta crawl and add the selected file to the Files FIFO Queue and process the files asynchronously with a Repo database. The system is configured to minimize the amount of data to be crawled using file properties to assess the need for a given file to be subject to crawl.

According to the system, prior to the execution of the crawl, the files are subject to a crawl via detection of a number of signatures which identify files that have changed since the last recorded crawl event. The files are identified as containing the desired signatures and only those files are subject to the crawl process and added to the index.

According to the disclosure, the system starts at the root folder where folders are added to a Folders First in First Out (FIFO) Queue. The system of the computer-implemented processes the folders and fetches child or children folders asynchronously with the file system database via system input output (IO) calls and file metadata.

According to the disclosure, the system further comprises the step of updating complete acknowledgement messages. The system further comprises the step of processing the files asynchronously with a Repo database via multiple threads that manage write file data.

According to the disclosure, the system minimizes the amount of content that is to be processed by any one iteration of the crawl and by utilizing available computing system resources that can enable crawl speed enhancements. Furthermore, adding files to the index of the system further comprises including an Update and upsert (or insert) into the index.

According to the disclosure, the file of the system comprises file properties configured to prevent a file from being crawled and the file is a temporary file or is specifically flagged not to be crawled.

According to further embodiments of the disclosure, a computer-implemented method of iterative file system crawling process informed by document signature flags of a performant file system using an Analytics Engine and an enterprise content management system is disclosed. The computer-implemented method comprises the steps of providing a computer processor, configuring the processor to couple with a network interface, configuring the processor, by a set of executable instructions storable in a memory to execute a pre-upsert process, the pre-upsert process configured to add documents to a document source and crawl the documents to create a baseline ES/OS Index contains the attributes of every document from the document source.

According to the disclosure, the process further comprises configuring the processor, by a set of executable instructions storable in a memory to execute a upsert process, the upsert process configured to examine documents in a document source (since the previous upsert process), determine changes in documents using signature flagging and the Shinydocs Search Library (SSL), crawl the documents to create an updated baseline ES/OS Index containing the attributes of every document from the document source and configuring the processor, by a set of executable instructions storable in a memory to re-execute the upsert process if changes are detected in the documents.

According to the disclosure, the content management system of the computer-implemented method minimizes the amount of content that is to be processed by any one iteration of the crawl and by utilizing available computing system resources that can enable crawl speed enhancements. The step of adding files to the index of the computer-implemented method further comprises including an Update and upsert (or insert) into the index.

According to the disclosure, the file of the computer-implemented method comprises file properties configured to prevent a file from being crawled and the file is a temporary file or is specifically flagged not to be crawled.

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented method of crawling data of a performant content system using an Analytics Engine and an enterprise content management system, the method comprising:
providing a computer processor;
configuring the processor to couple with a network interface;
configuring the processor, by a set of executable instructions storable in a memory, configured to:
add a folder to a first in first out (FIFO) folder queue;
process the folders and fetch child folders asynchronously;
select one or more files via a delta crawl and add the selected file to the Files FIFO Queue; and
process the files asynchronously with a Repo database;
wherein the method minimizes the amount of data to be crawled using file properties to assess the need for a given file to be subject to crawl;
wherein prior to the execution of the crawl, the files are subject to a crawl via detection of file signatures which identify files that have changed since the last recorded crawl event;
wherein files are identified as having new or modified signatures and only those files are subject to the crawl process and added to the index.

2. The computer-implemented method of claim 1 wherein the method starts at the root folder where folders are added to a Folders FIFO Queue.

3. The computer-implemented method of claim 1 wherein the system processes the folders and fetches child or children folders asynchronously with the content system database via system input output (IO) calls and file metadata.

4. The computer-implemented method of claim 1 further comprises the step of updating complete acknowledgement messages.

5. The computer-implemented method of claim 1 wherein the method further comprises the step of processing the files asynchronously with a Repo database via multiple threads that manage write file data.

6. The computer-implemented method of claim 1 wherein the method minimizes the amount of content that is to be processed by any one iteration of the crawl and by utilizing available computing system resources that can enable crawl speed enhancements.

7. The computer-implemented method of claim 1 wherein adding files to the index further comprises including an Update and upsert into the index.

8. The computer-implemented method of claim 1 wherein the file of the method comprises file properties configured to prevent a file from being crawled and the file is a temporary file or is specifically flagged not to be crawled.

9. A performant file system configured for crawling data in an enterprise content management system, the system comprising:
a computer processor;
one or more file share of the content management system configured to store one or more original document;
a content management system module configured to communicate with the file share of the content management system;
an analytics module;
a visualizer module configured to provide output and visualization of crawled data; and
an analytics engine, in communication with the content management system module and the visualizer and analytics modules, the analytics engine configured to:
add a folder to a first in first out (FIFO) folder queue;
process the folders and fetch child folders asynchronously;
select one or more files via a delta crawl and add the selected file to the Files FIFO Queue; and
process the files asynchronously with a Repo database;
wherein the system is configured to minimize the amount of data to be crawled using file properties to assess the need for a given file to be subject to crawl;
wherein prior to the execution of the crawl, the files are subject to a crawl via detection of file signatures which identify files that have changed since the last recorded crawl event;
wherein files are identified as new or modified signatures and only those files are subject to the crawl process and added to the index.

10. The system of claim 9 wherein the system starts at the root folder where folders are added to a Folders FIFO Queue.

11. The system of claim 9 wherein the system processes the folders and fetches child or children folders asynchronously with the file system database via system input output (IO) calls and file metadata.

12. The system of claim 9 wherein the system further comprises the step of updating complete acknowledgement messages.

13. The system of claim 9 wherein the system further comprises the step of processing the files asynchronously with a Repo database via multiple threads that manage write file data.

14. The system of claim 9 wherein the system minimizes the amount of content that is to be processed by any one iteration of the crawl and by utilizing available computing system resources that can enable crawl speed enhancements.

15. The system of claim 9 wherein adding files to the index further comprises including an Update and upsert into the index.

16. The system of claim 9 wherein the file of the system comprises file properties configured to prevent a file from being crawled and the file is a temporary file or is specifically flagged not to be crawled.

17. A computer-implemented method of iterative content system crawling process informed by document signature flags of a performant content system using an Analytics Engine and an enterprise content management system, the method comprising:
providing a computer processor;
configuring the processor to couple with a network interface;
configuring the processor, by a set of executable instructions storable in a memory to execute a pre-upsert process, the pre-upsert process configured to:
add documents to a document source;
crawl the documents to create a baseline Search Index containing the attributes of every document from the document source;
configuring the processor, by a set of executable instructions storable in a memory to execute a upsert process, the upsert process configured to:
examine documents in a document source (since the previous upsert process)
determine changes in documents using signature flagging and the Shinydocs Search Library (SSL);
crawl the documents to create an updated baseline Search Index containing the attributes of every document from the document source;
configuring the processor, by a set of executable instructions storable in a memory to re-execute the upsert process if changes are detected in the documents.

18. The computer-implemented method of claim 17 wherein the content management system minimizes the amount of content that is to be processed by any one iteration of the crawl and by utilizing available computing system resources that can enable crawl speed enhancements.

19. The computer-implemented method of claim 17 wherein adding files to the index further comprises including an Update and upsert into the index.

20. The computer-implemented method of claim 17 wherein the file of the method comprises file properties configured to prevent a file from being crawled and the file is a temporary file or is specifically flagged not to be crawled.
